(19) United States
(12) Patent Application Publication
(10) Pub. No.: US 2010/0001658 A1
(43) Pub. Date: Jan. 7, 2010

(54) LIGHT EMITTING DIODE CIRCUIT AND LIGHT EMITTING DIODE DRIVING CIRCUIT

(76) Inventor: Chih-Chien LEE, Taipei City (TW)

Correspondence Address: Chih Feng Yeh;BRIAN M. MCINNIS, 12th Floor, Ruttonjee House, 11 Duddell Street, Hong Kong, HK

(21) Appl. No.: 12/202,926

(22) Filed: Sep. 2, 2008

(30) Foreign Application Priority Data
Jul. 4, 2008 (TW) 97125307

(51) Int. Cl. H05B 41/16

(52) U.S. Cl. 315/291

(57) ABSTRACT

A light-emitting diode circuit and a light-emitting diode driving circuit are disclosed. The light-emitting diode driving circuit includes the DC-DC converter and the switch circuit. The DC-DC converter converts a DC voltage to the driving voltage for driving the light-emitting diode. One end of the switch circuit is electrically connected to the DC-DC converters and a cathode of the light-emitting diode, the other end of the circuit switching is electrically connected to a ground terminal. The switch circuit controls the connection between the DC-DC converters, the Light-emitting diodes and the ground terminal based on the control signal.

### RELATED APPLICATIONS

This application claims priority to Taiwan Application Serial Number 97125307, filed Jul. 4, 2008, which is herein incorporated by reference.

### BACKGROUND

1. Field of Invention

The present invention relates to a light emitting diode driving circuit. More particularly, the present invention relates to a blue light emitting diode driving circuit.

2. Description of Related Art

In existing server systems, in order to enable users to identify the current state of the server, the indicators are composed of light emitting diodes that show the current state of the server. For example, if the blue indicator lights up, it represents the UID button of the server has been pressed; if the green indicator lights up, it presents that the server system is operating normally.

In order to make these indicators, composed of the light emitting diodes, light up, the driving circuit must provide sufficient driving voltage to turn on the light emitting diode. To turn on the diode, the voltage provided by the driving circuit needs to be greater than the turn on voltage (threshold voltage) of the light emitting diode, so the DC-DC converters is usually employed to increase the voltage provided to conduct the light emitting diode. For example, the turn on voltage of the blue light emitting diode is required to be raised up to 3.3V.

However, when light-emitting diodes don't need to be turned on, the DC-DC converter still operates and consumes power, which causes unnecessary power consumption. Therefore, there is a need for a new light emitting diode driving circuit which can reduce the unnecessary power consumption.

### SUMMARY

According to one embodiment of the present invention, a light-emitting diode driving circuit includes a DC-DC converter and a switch circuit. The DC-DC converter transforms a DC voltage into a driving voltage for driving a light emitting diode. The switch circuit has one end electrically connected to the DC-DC converter and a cathode of the light emitting diode. The switch circuit also has the other end electrically connected to a ground terminal, in which the switch circuit controls the connection between the DC-DC converter, the light emitting diode and the ground terminal according to a control signal, such that the DC-DC converter and the light emitting diode are turned off by the switch circuit simultaneously.

According to another embodiment of the present invention, a light emitting diode circuit includes a light emitting diode, a DC-DC converter, and a switch circuit. The DC-DC converter transforms a DC voltage into a driving voltage for driving the light emitting diode. The switch circuit has one end electrically connected to the DC-DC converter and a cathode of the light emitting diode. The switch circuit also has the other end electrically connected to a ground terminal, in which the switch circuit controls the connection between the DC-DC converter, the light emitting diode and the ground terminal according to a control signal.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 shows the block diagram of the light-emitting diode circuit according to one embodiment of the present invention;

FIG. 2A shows the light emitting diode circuit according to another embodiments of the present invention;

FIG. 2B shows the light emitting diode circuit according to other embodiments of the present invention;

FIG. 3A shows the side view of the light emitting diode package structure according one embodiment of the present invention; and

FIG. 3B shows the front view of the light emitting diode package structure according one embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In the following embodiment, the DC-DC converters and the light emitting diode of the light emitting diode driving circuit or the light emitting diode circuit are turned off simultaneously if the light emitting diode doesn't need to light up thereby reducing unnecessary power consumption.

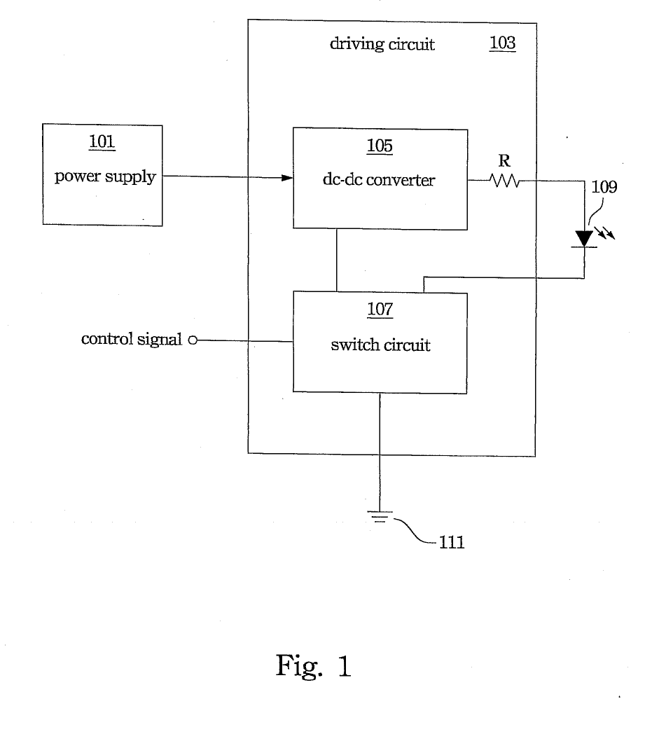

FIG. 1 shows the block diagram of the light-emitting diode circuit according to one embodiment of the present invention. The light emitting diode circuit includes the light emitting diode driving circuit 103 and the light emitting diode 109. The power supply 101 supplies the DC voltage to the driving circuit 103. The driving circuit 103 includes the DC-DC converter 105 and the switch circuit 107. The DC-DC converter 105 transforms the DC voltage supplied by the power supply 101 into driving voltage for driving the light emitting diodes 109.

In this embodiment, the light emitting diode 109 is a blue light emitting diode with a turn on voltage above 3.3V, and the power supply 101 only provides a DC voltage of 3.3V. Therefore, in order to light up the blue diode, the DC-DC converter 105 needs to increase the DC voltage provided by the power supply 101 up to more than 3.3V (increase to 5V for example); in the meantime, the power supply 101 can also provides other electronic components on the motherboard which require only 3.3V voltage without passing through the DC-DC converter 105.

The switch circuit 107 has one end electrically connected to the DC-DC converter 105 and a cathode of the light emitting diode 109, and has the other end electrically connected to the ground terminal 111, in which the switch circuit 107 controls the connection between the DC-DC converter 105, the light emitting diode 109 and the ground terminal 111 according to the control signal. Hence the DC-DC converter 105 and the light emitting diode 109 can be turned off simultaneously. For example, if the light emitting diode 109 doesn't need to light up, the control signal can make the switch circuit 107 disconnect the connection between the DC-DC converter 105, the light emitting diode 109 and the ground terminal 111. Thus, current can't be pass through the DC-DC converter 105 and the light emitting diode 109, then the DC-DC converter 105 and the light emitting diode 109 are turned off at the same time as a result.

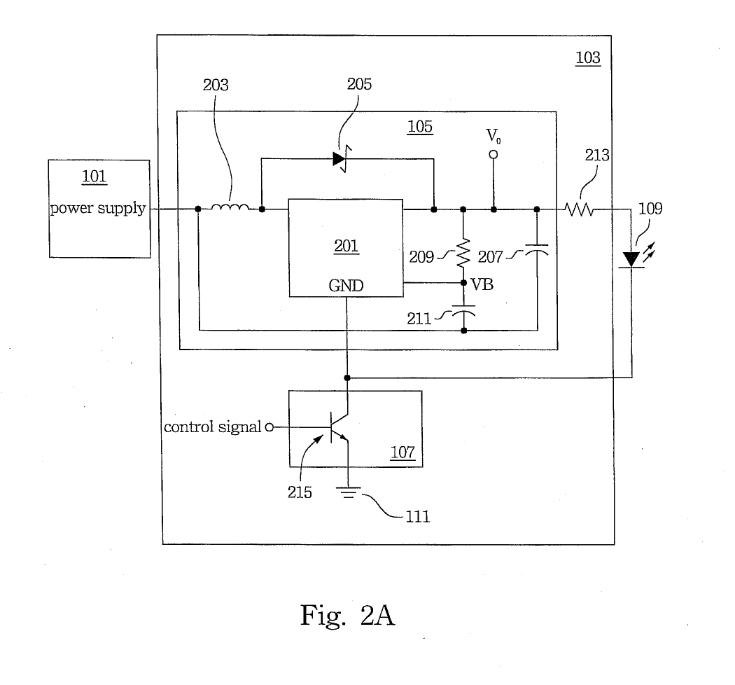

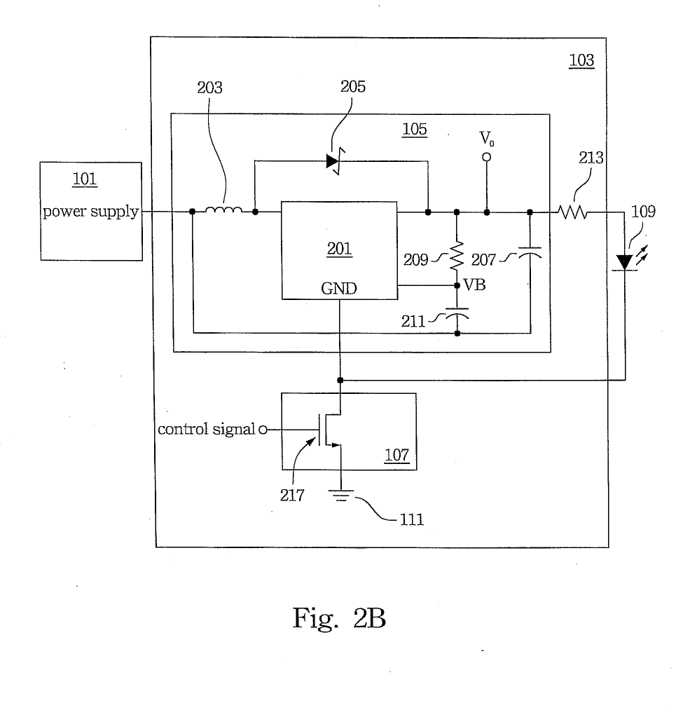

FIG. 2A and FIG. 2B show the light emitting diode circuit according to another embodiments of the present invention. The light emitting diode circuit includes the light emitting diode driving circuit 103. The power supply 101 supplies the driving circuit 103 the DC voltage. The driving circuit 103 includes the DC-DC converter 105 and the switch circuit 107. The DC-DC converter 105 transforms DC voltage supplied by the power supply 101 into driving voltage to drive the light emitting diodes 109.

The DC-DC converter 105 includes an inductor 203, a diode 205, a capacitor 207, and a controller 201. The diode 205 has an anode electrically connected to the inductor 203. A cathode of the diode 205 and a terminal of the capacitor 207 are electrically connected to a driving terminal V₀ to drive the light emitting diode 109. In this embodiment, the resistor 213 is electrically connected between the driving terminal V₀ and the light emitting diode 109 to tune the current volume flowing through the light emitting diode 109. The controller 201 is electrically connected to the cathode of the diode 205 and the terminal of the capacitor 207 to tune the terminal voltage of the capacitor 207 to drive the light emitting diode 109.

The DC-DC converter 105 further includes the resistor 209 and the capacitor 211 connected serially, in which one end of the resistor 209 is electrically connected to the driving terminal V₀, while the other end of the resistor 209 is electrically connected to the capacitor 211. With the resistor 209 and the capacitor 211, the controller 201 can sense the node voltage VB, and tunes the energy (current) storing period of the inductor 203 to, which further tunes the driving voltage on the driving terminal V₀.

The switch circuit 107 includes a bipolar junction transistor 215 that has a base receiving the control signal, a collector electrically connected to the DC-DC converter 105 and the cathode of the light emitting diode 109, and an emitter electrically connected to the ground terminal 111. The bipolar junction transistor 215 controls the connection between the DC-DC converter 105, the light emitting diode 109 and the ground terminal 111, such that the DC-DC converter 105 and the light emitting diode 109 can be turned off by the switch circuit 107 at the same time.

In detail, if the control signal received by the transistor 215 is logic 1, the transistor 215 turns on, which connects the DC-DC converter 105 and the light emitting diode 109 to the ground terminal 111, then the DC-DC converter 105 generates the driving voltage to light up the light emitting diode 109. On the contrary, if the control signal received by the transistor 215 is logic 0, the transistor 215 turns off, which disconnects the ground terminal 111 from the DC-DC converter 105 and the light emitting diode 109, then the DC-DC converter 105 stop generating the driving voltage, and the light emitting diode 109 turns off.

In addition to the bipolar junction transistor, the switch circuit 107 can also be implemented with a field effect transistor 217. The field effect transistor 217 has a gate receiving the control signal, a drain electrically connected to the DC-DC converter 105 and the cathode of the light emitting diode 109, and a source electrically connected to the ground terminal 111. Similar to the bipolar junction transistor 215, the field effect transistor 217 controls the connection from the DC-DC converter 105 and the light emitting diode 109 to the ground terminal 111.

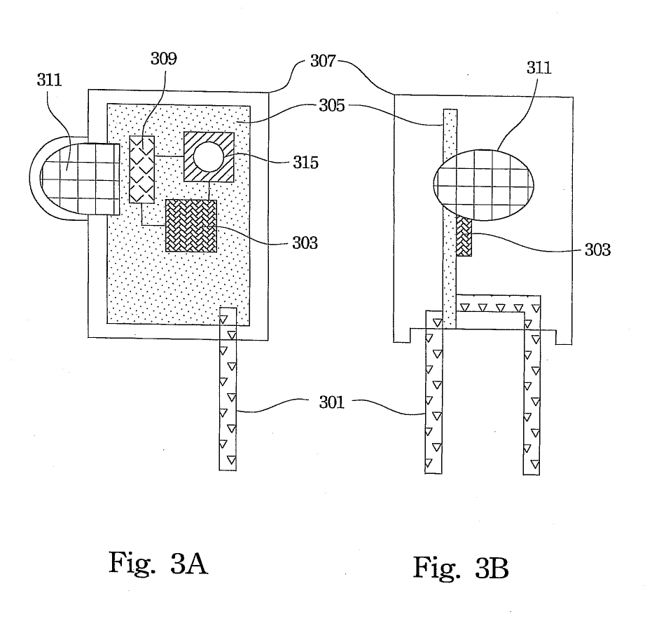

FIG. 3A and FIG. 3B show the side view and the front view of the light emitting diode package structure according one embodiment of the present invention. The light emitting diode package structure includes the lead frame 301, the printed circuit board 305, the DC-DC converter 303, the surface-mounted LED 309, the switch circuit 315, the covering 307, and the light guide pillar 311. The DC-DC converter 303, the surface-mounted LED 309, and the switch circuit 315 are disposed on the printed circuit board 305. The switch circuit 315 can be a push switch controlling the operation of the DC-DC converter 303 and the LED 309 in this embodiment. The lead frame 301 is coupled to the printed circuit board 305 for fixing the printed circuit board 305 and providing the power to the DC-DC converter 303, the surface-mounted LED 309, and the switch circuit 315.

The light guide pillar 311 is disposed around the surface-mounted LED 309 for collecting and guiding the light generated by the LED 309. The covering 307 covers and protects the components on the printed circuit board 305. In particular, because the DC-DC converter 303 is sufficient small to be packaged together with the LED 309, so the package structure can be used in various application.

According to the above embodiment, when light emitting diode needs not to light up, the switch circuit of the light emitting diode driving circuit and light emitting diode circuit can turn off the DC-DC converters and light emitting diode at the same time, which reduces the unnecessary power consumption.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A light-emitting diode driving circuit, comprising:
a DC-DC converter transforming a DC voltage into a driving voltage for driving a light emitting diode; and
a switch circuit having one end electrically connected to the DC-DC converter and a cathode of the light emitting diode, having the other end electrically connected to a ground terminal, wherein the switch circuit controls the connection between the DC-DC converter, the light emitting diode and the ground terminal according to a control signal, whereby the DC-DC converter and the light emitting diode are turned off simultaneously.

2. The light-emitting diode driving circuit as claimed in claim 1, wherein the switch circuit comprises a bipolar Junction transistor having a base receiving the control signal, a collector electrically connected to the DC-DC converter and the cathode of the light emitting diode, and an emitter electrically connected to the ground terminal.

3. The light-emitting diode driving circuit as claimed in claim 1, wherein the switch circuit comprises a field effect transistor having a gate receiving the control signal, a drain electrically connected to the DC-DC converter and the cathode of the light emitting diode, and a source electrically connected to the ground terminal.

4. The light-emitting diode driving circuit as claimed in claim 1, wherein the DC-DC converter increases the DC voltage supplied by a power supply for driving the light emitting diode.

5. The light-emitting diode driving circuit as claimed in claim 4, wherein the DC voltage supplied by the power supply is 3.3V, and the DC-DC converter increases the DC voltage to 5V.

6. The light-emitting diode driving circuit as claimed in claim 1, wherein the DC-DC converter comprises:
an inductor;
a diode having an anode electrically connected to the inductor;
a capacitor having a terminal electrically connected to a cathode of the diode; and
a controller electrically connected to the cathode of the diode and the terminal of the capacitor for tuning the terminal voltage of the capacitor.

7. A light emitting diode circuit, comprising:
a light emitting diode;
a DC-DC converter transforming a DC voltage into a driving voltage for driving the light emitting diode; and
a switch circuit having one end electrically connected to the DC-DC converter and a cathode of the light emitting diode, having the other end electrically connected to a ground terminal, wherein the switch circuit controls the connection between the DC-DC converter, the light emitting diode and the ground terminal according to a control signal.

8. The light emitting diode circuit as claimed in claim 7, wherein the switch circuit comprises a bipolar Junction transistor having a base receiving the control signal, a collector electrically connected to the DC-DC converter and the cathode of the light emitting diode, and an emitter electrically connected to the ground terminal.

9. The light emitting diode circuit as claimed in claim 7, wherein the switch circuit comprises a field effect transistor having a gate receiving the control signal, a drain electrically connected to the DC-DC converter and the cathode of the light emitting diode, and a source electrically connected to the ground terminal.

10. The light emitting diode circuit as claimed in claim 7, wherein the light emitting diode is a blue light emitting diode.

11. The light emitting diode circuit as claimed in claim 7, wherein the DC-DC converter increases the DC voltage supplied by a power supply for driving the light emitting diode.

12. The light emitting diode circuit as claimed in claim 7, wherein the DC voltage supplied by the power supply is 3.3V, and the DC-DC converter increases the DC voltage to 5V.
